(19) United States
(12) Patent Application Publication
(10) Pub. No.: US 2026/0342065 A1
(43) Pub. Date: Oct. 29, 2026

(54) ELECTRICAL CONDUIT SUPPORT FOR ROOF DECKS

(71) Applicants: Henry Gembala, Delray Beach, FL (US); David Gembala, Delray Beach, FL (US)

(72) Inventors: Henry Gembala, Delray Beach, FL (US); David Gembala, Delray Beach, FL (US)

(21) Appl. No.: 19/189,651

(22) Filed: Apr. 25, 2025

(51) Int. Cl. H02G 3/34; E04D 13/14; F16L 5/00

(52) U.S. Cl. CPC H02G 3/34; E04D 13/14; F16L 5/00

(57) ABSTRACT

An electrical conduit support post includes a rigid pipe that penetrates through a roof deck and a pipe boot that surrounds the rigid pipe. A mounting plate is fixed to a bottom end of the pipe boot for attachment to the roof deck with screw fasteners. Flashing is applied to cover and seal the mounting plate and the penetration through the roof deck, and an approved sealant is applied around the base of the pipe boot above the flashing. Electrical conduit extends through the rigid pipe from an interior of a building structure, through the roof deck and exits a cap that is sealed to the top end of the rigid pipe at an adjusted height above the roof deck.

### BACKGROUND OF THE INVENTION

### Field of the Invention

The present invention relates to support structures for electrical conduit penetrating through a roof deck to provide electric power for equipment on a rooftop and, more particularly, to an electrical conduit support structure that reduces the amount of penetrations through the roof deck to thereby reduce the risk of roof leaks.

### Description of the Related Art

Currently, any electrical conduit penetrating a roof system, such as on a commercial building, is supported to an adjoin stand. The adjoin stand needs to be mounted to the roof deck and is usually fabricated with two legs and a Unistrut joining the two legs and allowing the electrical conduit to be secured to the Unistrut. This current method for supporting electrical conduit above a roof deck requires three penetrations through the roof system and three flashings at three locations on the roof deck. This is less than desirable due to the fact that roof penetrations are usually a contributing factor of roof leaks. It is, therefore, preferable to reduce the amount of penetrations through the roof system, thereby reducing the risk of roof leaks.

### SUMMARY OF THE INVENTION

The present invention is directed to an electrical conduit support apparatus that limits the amount of penetrations through the roof system to a single penetration, to thereby reduce the risk of roof leaks, while saving installation time and money.

The electrical conduit support apparatus includes a rigid pipe that extends through the entire thickness of the roof deck, from an interior of a building structure to a desired height above the roof deck. An electrical conduit extends through the rigid pipe from the interior of the building structure and exits a top end of the rigid pipe for electrical connection with a disconnect switch or other electrical supply component for supplying electrical power to rooftop equipment. A pipe boot surrounds the rigid pipe and includes a mounting plate at a bottom end for attachment to the roof deck. In a preferred embodiment, the mounting plate is attached to the roof deck with approved screw fasteners. Flashing is applied over the mounting plate to cover and seal the plate and the penetration through the roof deck. An approved sealant is applied around the base of the pipe boot above the flashing. An upper end of the pipe boot terminates below the top end of the rigid pipe. In a preferred embodiment, the pipe boot has an inner diameter that is slightly larger than the outer diameter of the rigid pipe so that the pipe boot surrounds and supports the rigid pipe. More particularly, the pipe boot and mounting plate support the rigid pipe and electrical conduit in a fixed, vertical position above the roof deck, thereby providing a built-in stand as part of the electrical conduit support apparatus. A skirt-shaped umbrella is secured to the exterior of the rigid pipe above the top end of the pipe boot to protect against rain and other elements of the weather from entering through the top of the pipe boot. The top end of the rigid pipe may include a cap fitted thereto, or, in another embodiment, the top end of the rigid pipe may be connected to a horizontal frame member or another electrical power supply component.

### BRIEF DESCRIPTION OF THE DRAWINGS

For a fuller understanding of the nature of the present invention, reference should be had to the following detailed description taken in connection with the accompanying drawings in which:

FIG. 1 is an elevational view, in partial cross-section, generally illustrating the electrical conduit support stand of the present invention;

FIG. 2 is a bottom perspective view of the electrical conduit support stand of FIG. 1 including a rigid pipe for accommodating passage of an electrical conduit therethrough, a pipe boot surrounding the rigid pipe and a mounting plate;

FIG. 3 is an elevational view, shown in cross-section, illustrating the components of the electrical conduit support stand of the present invention;

FIG. 4 is an elevational view, shown in cross-section, illustrating a further embodiment of the electrical conduit support stand of the present invention; and

FIG. 5 is a bottom plan view of the mounting plate.

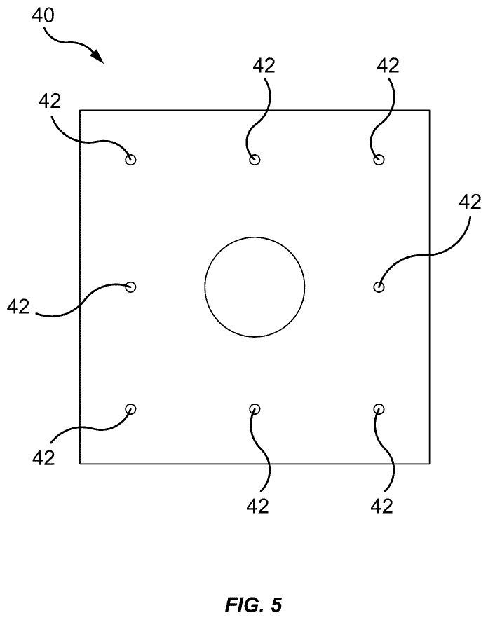

Like reference numerals refer to like parts throughout the several views of the drawings.

### DETAILED DESCRIPTION OF THE PREFERRED EMBODIMENT

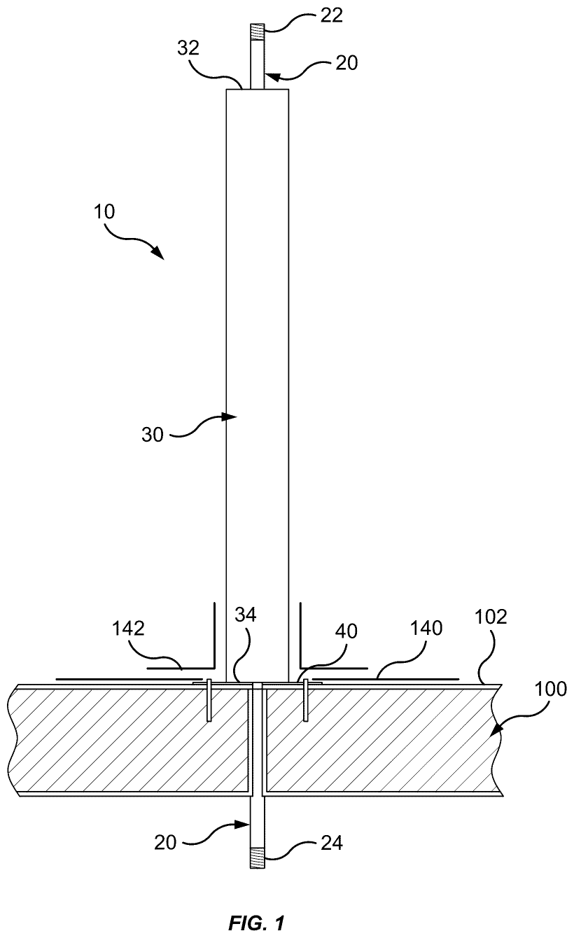

Referring to FIGS. 1-4, the electrical conduit support apparatus of the present invention is shown and is generally indicated as 10. The electrical conduit support apparatus 10 limits the amount of penetrations through the roof system to a single penetration, to thereby reduce the risk of roof leaks.

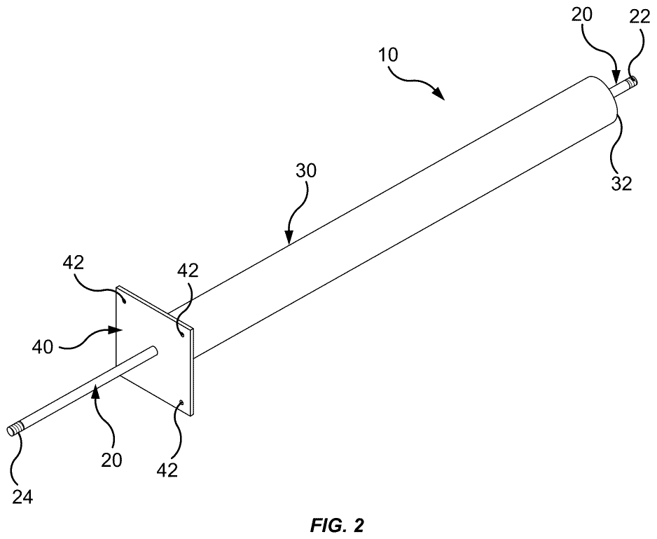

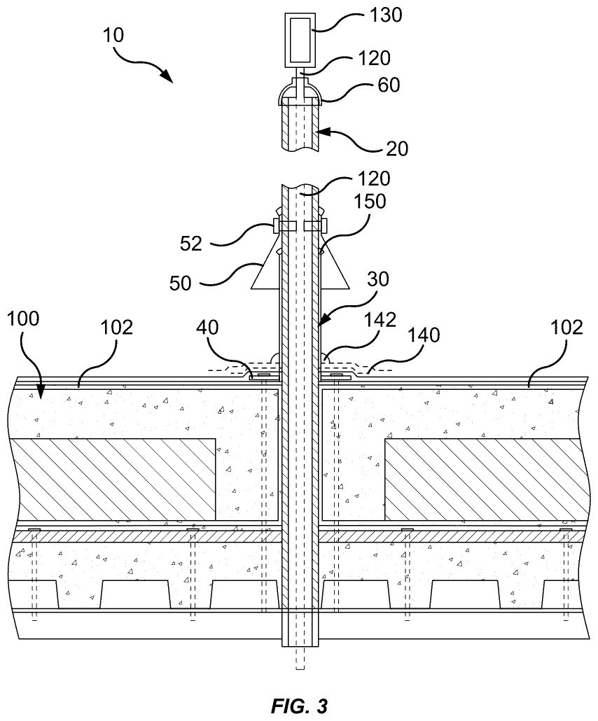

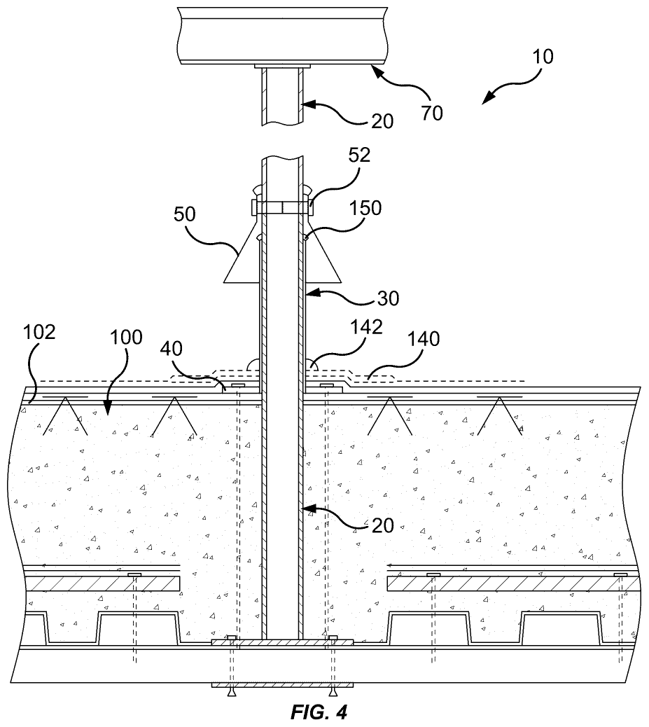

The electrical conduit support apparatus 10 includes a rigid pipe 20 that extends through the entire thickness of the roof deck 100, from an interior of a building structure to a desired height above the roof deck. The rigid pipe 20 is specifically sized to allow passage of an electrical conduit 120 therethrough (see FIG. 3), from an interior of the building to a switch box 130 or other device mounted above the top end 22 of the rigid pipe 20. In a preferred embodiment, the rigid pipe 20 has an inner diameter of between ¾ inch to 3 inches and is approximately ¼ inch thick and is preferably formed of aluminum or stainless steel that does not rust or require replacement. The rigid pipe 20 may also be threaded at the top end 22, as well as the bottom end 24 if desired (see FIGS. 1 and 2). A pipe boot 30 surrounds a portion of the rigid pipe 20 from the top 102 of the roof deck 100 to a height below the top end 22 of the rigid pipe 20. The pipe boot 30 is formed of stainless steel or aluminum and has an inner diameter that is slightly larger than the outer diameter of the rigid pipe 20. The pipe boot 30 is mounted to the top 102 of the roof deck 100 with a stainless steel or aluminum plate 40 that is welded to the bottom end 34 of the pipe boot 30. The mounting plate 40 includes a number of holes 42, at least at its four corners, to allow the mounting plate 40 to be secured to the roof deck 100 with approved screw fasteners. Flashing 140 is then applied over the mounting plate 40 and around the base of the pipe boot 30. An approved liquid sealant 142 is applied about the base of the pipe boot 30 above the flashing 140. The pipe boot 30 and mounting plate 40 support the rigid pipe 20 and electrical conduit 120 in a fixed, vertical position above the roof deck, thereby providing a built-in stand as part of the electrical conduit support apparatus 10. The top end 32 of the pipe boot 30, where the rigid pipe 20 exits, is closed and sealed with an approved sealant 150 so that rain or moisture does not enter between the pipe boot 30 and the rigid pipe 20. A skirt-shaped umbrella 50 is secured 360 degrees around the exterior of the rigid conduit passage pipe 20 with strapping or adjustable band 52. In one preferred embodiment, the umbrella 50 and adjustable band 52 are formed of stainless steel. The umbrella 50 is positioned above the top end 32 of the pipe boot 30 to shield the top end of the pipe boot from rain and other weather elements. A cap 60 (see FIG. 3) or rigid metal horizontal frame member 70 (see FIG. 4) is welded to the top end 22 of the rigid pipe 20. The electrical conduit 120 then extends through the entire length of the rigid pipe 20 from an interior of the building, and through the top end 22 and the cap 60 or horizontal frame member 70 for connection to an electrical switch box or other equipment on the rooftop. Electrical wire conductors can then be extended through the conduit 120 to supply power to rooftop equipment.

Since many modifications, variations and changes in detail can be made to the described embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A support apparatus for electrical conduit extended through a roof deck, the support apparatus comprising:
an elongated rigid pipe that is structured to extend through a penetration in the roof deck from an interior of a building structure to a height above a top of the roof deck, and the elongated rigid pipe including an inner diameter sized for passage of the electrical conduit therethrough and an exterior surface having an outer diameter, and the rigid pipe further including a top end positionable above a top of the roof deck and a bottom end positionable below the roof deck;
a rigid pipe boot having a top end, a bottom end, an inner diameter that is larger than the outer diameter of the elongated rigid pipe, and the rigid pipe boot further including an exterior surface having an outer diameter;
a mounting plate fixed to the bottom end of the rigid pipe boot for attachment to the top of the roof deck; and
the rigid pipe boot and mounting plate structured and disposed for supporting the elongated rigid pipe and electrical conduit in a fixed, vertically extending position above the roof deck.

2. The support apparatus as recited in claim 1 wherein the mounting plate includes a plurality of holes formed therethrough for attaching the mounting plate to the top of the roof deck using screw fasteners.

3. The support apparatus as recited in claim 2 wherein the top end of the rigid pipe boot terminates below the top end of the elongated rigid pipe.

4. The support apparatus as recited in claim 3 further comprising:
a skirt-shaped umbrella structured and disposed for attachment about the exterior surface of the elongated rigid pipe above the top end of the rigid pipe boot for shielding the top end of the rigid pipe boot from weather elements.

5. The support apparatus as recited in claim 4 further comprising:
a cap fixedly attached to the top end of the elongated rigid pipe and including an opening therethrough for passage of the electrical conduit above the elongated rigid pipe and the cap.

6. The support apparatus as recited in claim 4 wherein the top end of the elongated rigid pipe is attached to a horizontal frame member.

7. The support apparatus as recited in claim 5 wherein the entire support apparatus is formed of corrosion resistant materials.
